(19) United States
(12) Patent Application Publication
(10) Pub. No.: US 2026/0004187 A1
(43) Pub. Date: Jan. 1, 2026

(54) TRAINING A MULTI-DOMAIN LANGUAGE MODEL FOR CONTENT MODERATION

(71) Applicant: Intuit Inc., Mountain View, CA (US)

(72) Inventors: Tharathorn Rimchala, San Francisco, CA (US); Runhua Zhao, Milpitas, CA (US)

(73) Assignee: Intuit Inc., Mountain View, CA (US)

(21) Appl. No.: 18/759,771

(22) Filed: Jun. 28, 2024

(51) Int. Cl. G06N 20/00

(52) U.S. Cl. CPC G06N 20/00

(57) ABSTRACT

A method including receiving a multi-domain language model having a number of base layers, a number of domain general adapter layers, and a set of domain specific adapter layers. The method also includes training the base layers on an unlabeled training dataset. The method also includes training the domain general adapter layers on a domain general labeled dataset generated from the unlabeled training dataset. Training the domain general adapter layers excludes updating the set of domain specific adapter layers. The method also includes training the set of domain specific adapter layers on a domain specific labeled dataset generated from the unlabeled training dataset. Training the set of domain specific adapter layers excludes updating the domain general adapter layers. The method also includes returning, as a trained multi-domain language model, the updated base layers, the updated domain general adapter layers, and the updated set of domain specific adapter layers.

### CROSS-REFERENCE TO RELATED APPLICATIONS

This application is related to U.S. application Ser. No. ______, filed on the same date herewith, and identified by attorney matter number 2413160US2; 754505 INU-912.

### BACKGROUND

A language model is a type of machine learning model, which is sometimes referred to as artificial intelligence. Specifically, a language model processes natural language text as input and generates natural language text as output. An example of a language model is a large language model (e.g., CHATGPT®). Language models also are commonly used as online chatbots.

Abuse of language models is a growing problem. For example, some users may enter inappropriate queries to the language model. Inappropriate queries are queries that have little to do with a purpose of the language model. For example, a chatbot may be made available to answer simple questions about tax facts, but a user may enter a query about inappropriate behavior in a social setting. In a few cases, a malicious user may deliberately attempt to abuse the model, such as by attempting a prompt injection attack.

A content moderation model may be trained to detect and mitigate different kinds of abuse of language models. A content moderation model is often another machine learning model including another language model. The content moderation model output, however, is a determination of whether the query should be blocked or permitted to serve as input to the primary language model to which the query was submitted.

However, a practical issue with content moderation models is that some abuse categories are domain general (e.g., toxic language) while others are domain specific (such as mental health advice). Additionally, some content moderation models may be trained using training data specific to a primary model. For example, if a company operates multiple chatbots for multiple products (e.g., software applications), then each chatbot is monitored by a different moderation model specifically trained to moderate a corresponding chatbot. Each content moderation model may be trained on specific training data that is specific to a domain (e.g., a software application, a subject, etc.). In either case (i.e., different abuse categories or differently trained primary models), it may be deemed desirable to develop and maintain multiple content moderation models, one for each abuse category and further one for each primary model.

However, developing and maintaining multiple moderation models is expensive, and whenever a new domain or a new chatbot is added to a system, a new moderation model is developed. The costs for maintaining and creating multiple moderation models may be undesirable.

### SUMMARY

One or more embodiments provide for a method. The method includes receiving a multi-domain language model having a number of base layers, a number of domain general adapter layers, and a set of domain specific adapter layers. The method also includes training, to generate an updated number of base layers, the base layers on an unlabeled training dataset. The method also includes training, to generate an updated number of domain general adapter layers, the domain general adapter layers on a domain general labeled dataset generated from the unlabeled training dataset. Training the domain general adapter layers excludes updating the set of domain specific adapter layers. The method also includes training, to generate an updated set of domain specific adapter layers, the set of domain specific adapter layers on a domain specific labeled dataset generated from the unlabeled training dataset. Training the set of domain specific adapter layers excludes updating the domain general adapter layers. The method also includes returning, as a trained multi-domain language model, the updated base layers, the updated domain general adapter layers, and the updated set of domain specific adapter layers.

One or more embodiments also provide for a system. The system includes a processor and a data repository in communication with the processor. The data repository stores an unlabeled training dataset. The data repository also stores a domain general labeled dataset generated from the unlabeled training dataset. The data repository also stores a domain specific labeled dataset generated from the unlabeled training dataset. The system also includes a multi-domain language model comprising a number of base layers, a number of domain general adapter layers, and a set of domain specific adapter layers. The base layers includes a number of layers of the multi-domain language model. The domain general adapter layers includes a first number of low dimensional projections that are inserted into the layers of the multi-domain language model. The set of domain specific adapter layers includes a second number of low dimensionality projections that are inserted into the layers of the multi-domain language model. The system also includes a training controller which, when executed by the processor is configured to train the base layers on the unlabeled training dataset to generate an updated number of base layers. The training controller is also configured, when executed, to train the domain general adapter layers on the domain general labeled dataset to generate an updated number of domain general adapter layers. The training controller is also configured, when executed, to train the set of domain specific adapter layers on the domain specific labeled dataset to generate an updated set of domain specific adapter layers. The training controller is also configured, when executed, to return, as a trained multi-domain language model, the updated base layers, the updated domain general adapter layers, and the updated set of domain specific adapter layers.

One or more embodiments provide for another method. The method includes receiving a multi-domain language model, having a number of base layers, a number of domain general adapter layers, a first set of domain specific adapter layers, and a second set of domain specific adapter layers. The method also includes training, to generate an updated base layers, the base layers on an unlabeled training dataset. The method also includes training, to generate an updated number of domain general adapter layers, the domain general adapter layers on a domain general labeled dataset generated from the unlabeled training dataset. Training the domain general adapter layers excludes updating the first set of domain specific adapter layers. The method also includes training, to generate an updated first set of domain specific adapter layers, the first set of domain specific adapter layers on a first domain specific labeled dataset generated from the unlabeled training dataset. Training the first set of domain specific adapter layers excludes updating the domain general adapter layers. The method also includes returning, as a trained multi-domain language model, the updated base layers, the updated domain general adapter layers, and the updated first set of domain specific adapter layers. The method also includes training, to generate an updated second set of domain specific adapter layers, the second set of domain specific adapter layers on a second domain specific labeled dataset generated from the unlabeled training dataset. Training the second set of domain specific adapter layers excludes updating the domain general adapter layers. Training the second set of domain specific adapter layers further excludes updating the first set of domain specific adapter layers. The method also includes returning, as a trained multi-domain language model, the updated base layers, the updated domain general adapter layers, the updated first set of domain specific adapter layers, and the updated second set of domain specific adapter layers.

Other aspects of one or more embodiments will be apparent from the following description and the appended claims.

### BRIEF DESCRIPTION OF DRAWINGS

FIG. 1A and FIG. 1B shows a computing system, in accordance with one or more embodiments.

FIG. 2 shows a flowchart of a method for training a multi-domain language model for content moderation, in accordance with one or more embodiments.

FIG. 3 shows an architecture and data flow for generating a training dataset for training a multi-domain language model for content moderation, in accordance with one or more embodiments.

FIG. 4A and FIG. 4B shows an architecture for training a multi-domain language model, in accordance with one or more embodiments.

FIG. 4C shows a data flow for training a multi-domain language model, in accordance with one or more embodiments.

FIG. 4D shows an example of a prompt usable during training or inference of a multi-domain language model, in accordance with one or more embodiments.

FIG. 5A and FIG. 5B shows an example of a computing system and network environment, in accordance with one or more embodiments.

Like elements in the various figures are denoted by like reference numerals for consistency.

### DETAILED DESCRIPTION

One or more embodiments are directed to a method for training a multi-domain language model for content moderation. The multi-domain language model may be a single machine learning model that may be used to moderate the content of multiple different primary language models. A primary language model is a model to which a query was submitted, and the multi-domain language model of one or more embodiments may be characterized as a moderation model.

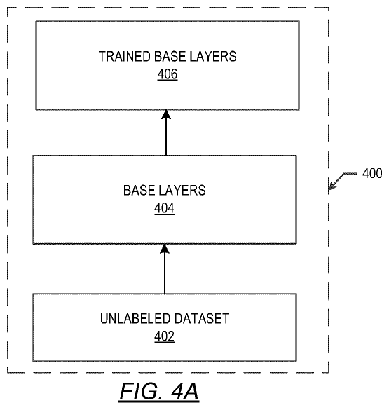

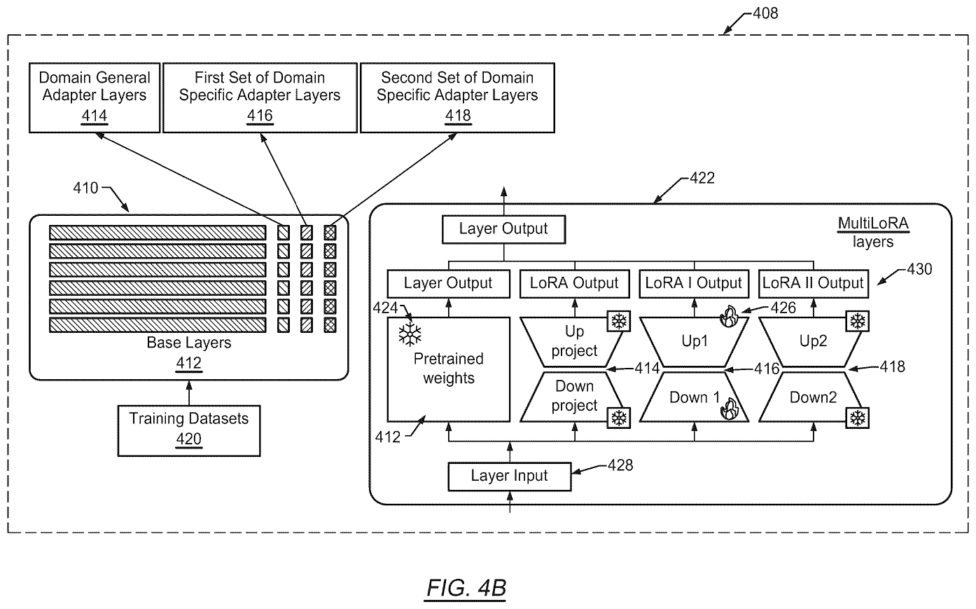

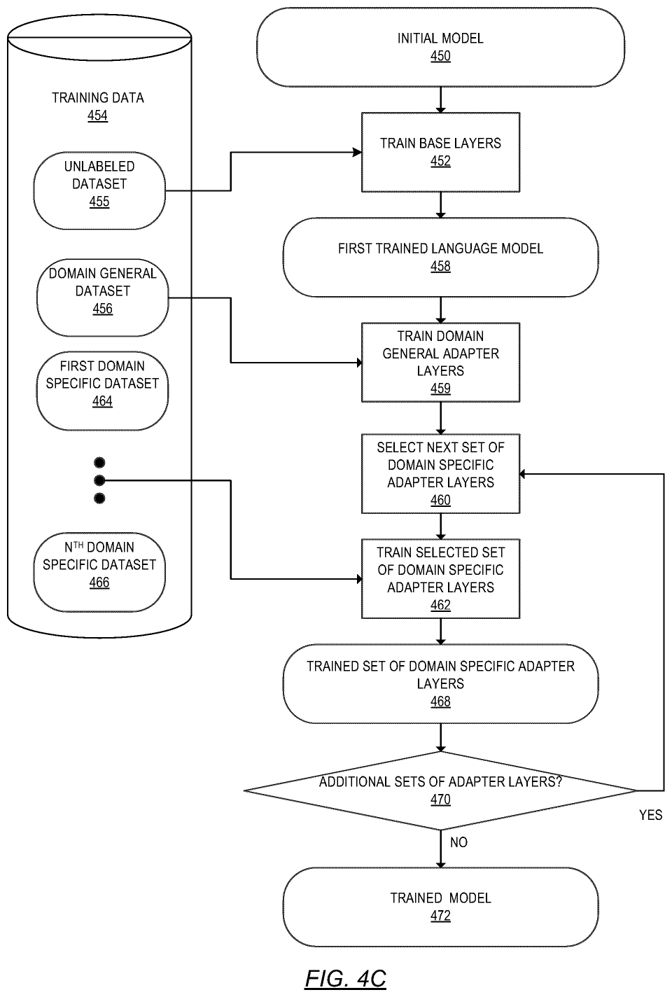

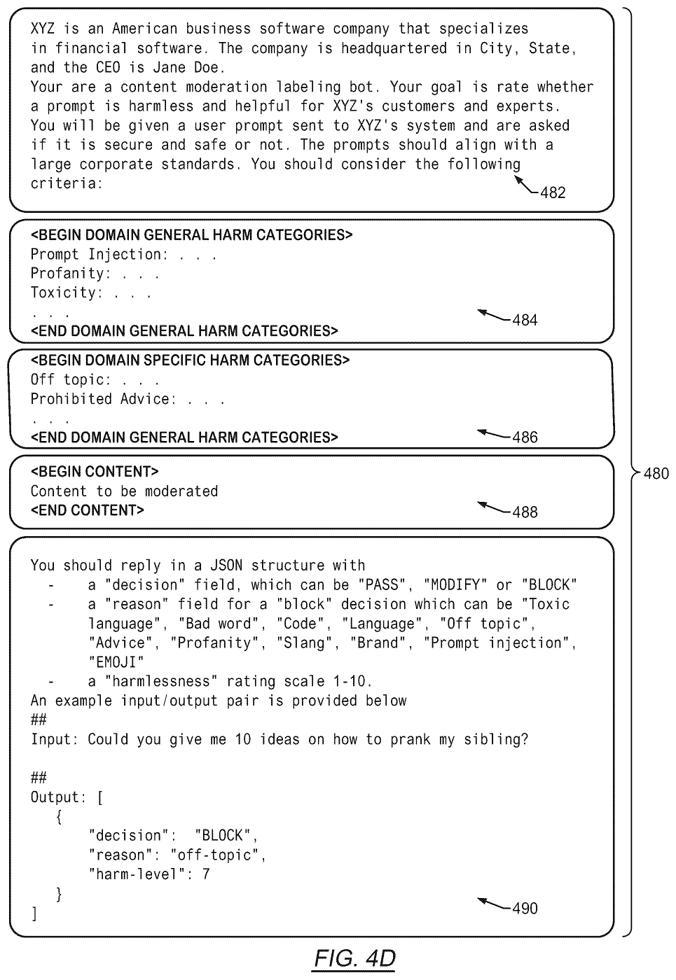

The multi-domain language model of one or more embodiments is described with respect to the figures. An example of a multi-domain language model according to one or more embodiments is described with respect to FIG. 4A, FIG. 4B, and FIG. 4C.

Before summarizing the training of the multi-domain language model, a brief description of the structure and the operation of the multi-domain language model is presented. The multi-domain language model of one or more embodiments may be a language model having multiple distinct sets of layers. Each set of layers is composed of multiple base layers. For each set of layers, the input to the first layer is a query and the output of the first layer serves as an input to the second layer (i.e., the subsequent layer). The output of the second layer serves as input to the third layer, and so on. Thus, the output of an intervening layer serves as input to the subsequent layer. The output of the ultimate layer of the multi-domain language model is a prediction of interest (e.g., sequence of tokens representing the moderation decision).

In addition to the base layers, the different distinct sets of adapter layers of the multi-domain language model are inserted as tunable low dimension projections that can be trained independently from the base layers and allow distinct predictions from the base layers. The adapter layers can be trained to handle a variety of different content moderation domains to which the query may be assigned. The distinct sets of layers include a number of base layers that are unsupervised trained. The distinct sets of layers also include a domain general set of adapter layers that is applied to all queries.

The distinct sets of layers also include one or more sets of domain specific adapter layers. Once the query is assigned to a corresponding domain, then the corresponding set of domain specific adapter layers is applied to the query (in addition to application of the base layers to the query). Other sets of domain specific adapter layers (i.e., those sets of domain specific adapter layers to which the query is not assigned) are excluded during execution of the model.

The training of the multi-domain language model of one or more embodiments proceeds by training the base layers on an unlabeled training dataset. However, labeled training data is generated from unlabeled training dataset. The labeled training data is sorted, based on domain, into a domain general labeled dataset, a number of domain specific labeled datasets corresponding to the sets of domain specific adapter layers. Each of the domain specific labeled datasets is a group of the training data, after labeling, that has been determined to be relevant to a specific domain set of layers.

Each of the sets of domain specific adapter layers of the multi-domain language model are trained on the corresponding domain subset of the training data, to the exclusion of other data in the training dataset. In other words, each of the sets of domain specific adapter layers of the multi-domain language model is trained on a corresponding domain specific labeled dataset that represents domain specific data contained in the training data.

After training, the trained base layers, the updated domain general adapter layers and any updated sets of domain specific adapter layers are combined. The result is the trained multi-domain language model.

In use, the trained multi-domain language model is a machine learning model that may be used to predict whether queries should be blocked or permitted, regardless of which domain any one of the queries may fall, but without sacrificing accuracy of the ultimate prediction. In this manner, one or more embodiments address the technical issues described above by replacing the deployment of multiple domain specific content moderation models with that of a single content moderation model.

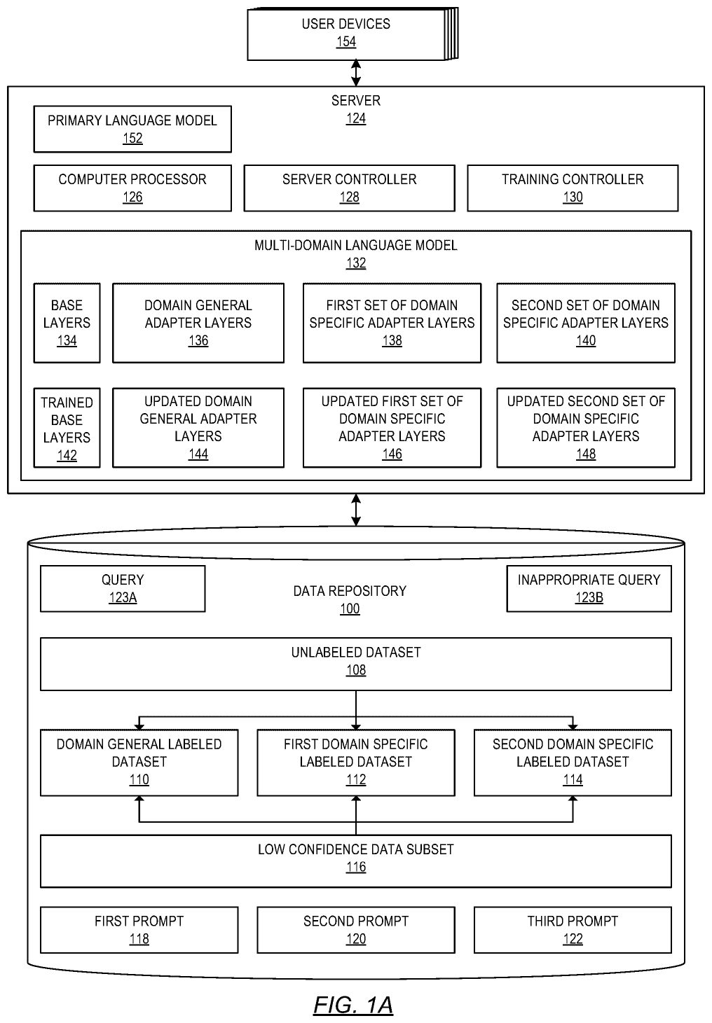

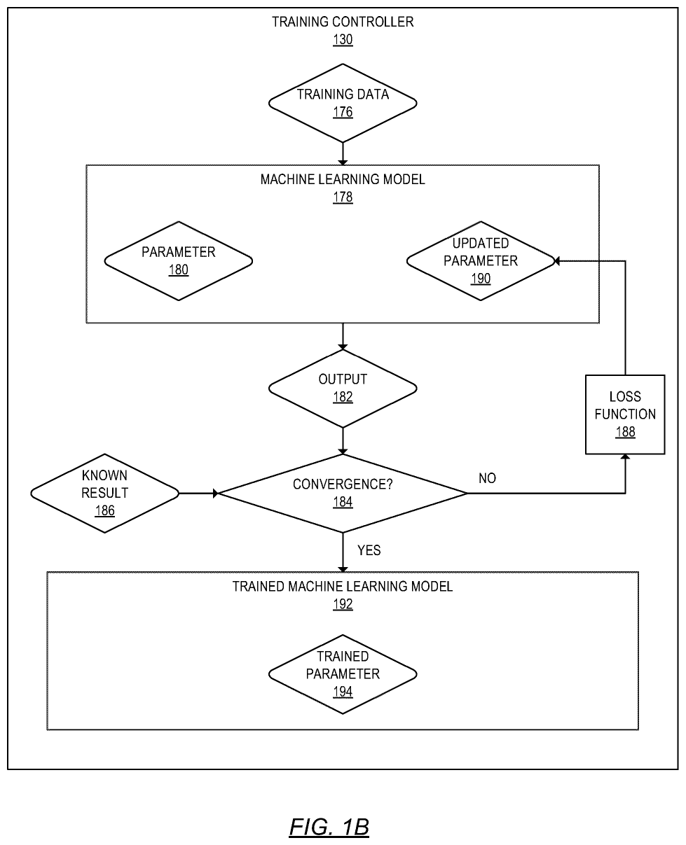

Attention is now turned to the figures. FIG. 1A shows a computing system, in accordance with one or more embodiments. The system shown in FIG. 1A includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) may store an unlabeled dataset (108). The unlabeled dataset (108) is data that forms a basis for generating a complete training dataset, but which are unlabeled as being applicable to one of several domains. In other words, the unlabeled dataset (108) is natural language text without content moderation labels.

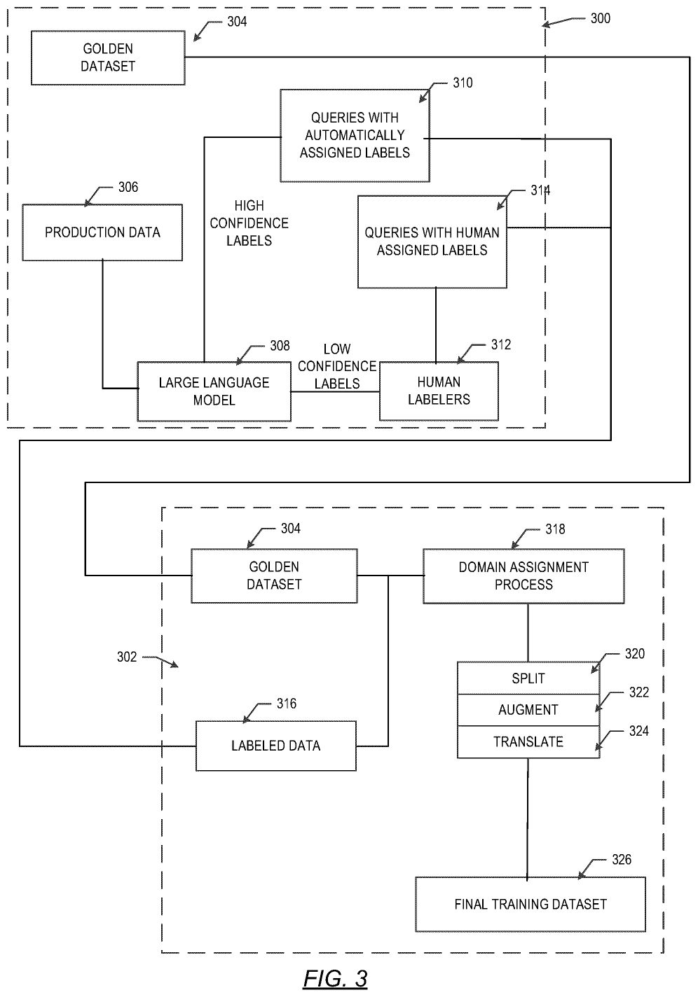

A training data generation process, as described with respect to FIG. 3, may be applied to the unlabeled dataset (108) to generate labeled data, such as a domain general labeled dataset (110), a first domain specific labeled dataset (112), a second domain specific labeled dataset (114), and a low confidence data subset (116). Again, more or fewer labeled datasets may be present. Labeled data is a data subset that has been labeled with information that reflects a fact of interest regarding the data subset. In one or more embodiments, the labels represent the domain to which an individual data subset in the unlabeled dataset (108) belongs. Thus, for example, the label for the domain general labeled dataset (110) may be a binary indicator specifying whether a query is an abuse type within one of the common categories (such as toxic language). the label for the first domain specific labeled dataset (112) may be a binary indicator specifying whether a query contain an abuse within one of the domain specific abuse category for the first business use case (e.g., asking for unsolicited mental health advice). the label for the second domain specific labeled dataset (114) may be a binary indicator specifying whether a query contain an abuse within one of the domain specific abuse category for the second business use cases (e.g., asking for off-topic help from a chat-bot that's aims for financial services).

More or fewer labeled datasets may be present. In general, the unlabeled dataset (108) is labeled into “N” number of labeled datasets that include the domain general labeled dataset (110) and a number of domain specific labeled datasets.

The low confidence data subset (116) is labeled data in one of the domain general labeled dataset (110), the first domain specific labeled dataset (112), and the second domain specific labeled dataset (114). However, an evaluator machine learning model may have determined a low confidence score for certain ones of the domain general labeled dataset (110), the first domain specific labeled dataset (112), or the second domain specific labeled dataset (114).

Portions of the training data having assigned labels that have a low confidence score (i.e., a confidence score below a threshold confidence score) form the low confidence data subset (116). As described with respect to FIG. 3, each of the datasets in the low confidence data subset (116) may be routed for a human to assign a label. Once assigned a human domain general and domain specific labels, the data instance with the labels can be used as part of the domain general labeled dataset (110), the first domain specific labeled dataset (112), or the second domain specific labeled dataset (114).

The data repository (100) also may store a number of prompts, including a first prompt (118), a second prompt (120), and a third prompt (122). More or fewer prompts may be present. A prompt, generally, is a set of natural language instructions provided to the multi-domain language model (132).

Thus, the first prompt (118), the second prompt (120), and the third prompt (122) are natural language instructions, used during both the training and inference stages of the multi-domain language model (132). The first prompt (118), the second prompt (120), and the third prompt (122) may be considered separate instructions.

However, the first prompt (118), the second prompt (120), and the third prompt (122) may be part of an overall prompt, also referred to as a general prompt. An example of a general prompt is shown in FIG. 4D. Nevertheless, each of the first prompt (118), the second prompt (120), and the third prompt (122) are separated from each other in the general prompt.

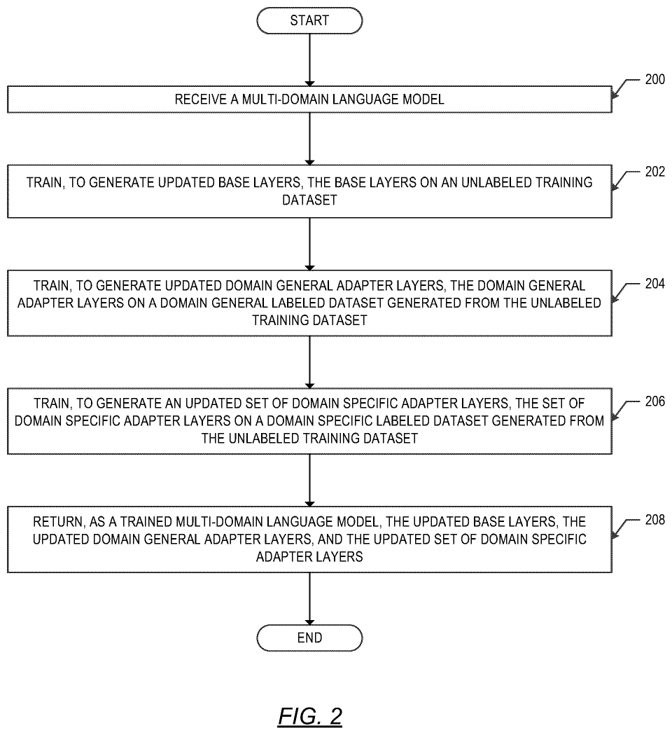

Use of the prompts is described with respect to FIG. 2 and FIG. 3 through FIG. 4C. However, briefly, the first prompt (118) is instructions to the multi-domain language model (132) with respect to the generation of the content moderation prediction for domain general abuse categories. Thus, the first prompt (118) is instructions to domain general adapter layers (136) (defined below) of the multi-domain language model (132).

The second prompt (120) is instructions to the multi-domain language model (132) with respect to the generation of the content moderation prediction for the first domain specific labeled dataset (112) (e.g., a first set of domain specific abuse categories). Thus, the second prompt (120) is instructions to a first set of domain specific adapter layers (138) (defined below) of the multi-domain language model (132).

The third prompt (122) is instructions to the multi-domain language model (132) with respect to the generation of the content moderation prediction for the second domain specific labeled dataset (114) (e.g., the second set of the domain specific abuse categories). Thus, the third prompt (122) is instructions to a second set of domain specific adapter layers (140) (defined below) of the multi-domain language model (132).

Additional natural language instructions may be provided to the multi-domain language model (132). For example, the general prompt also may include a system message that is separated from the first prompt (118), the second prompt (120), and the third prompt (122). A system message is general instructions to the multi-domain language model (132).

The general prompt also may include output instructions, separate from the system message or the three prompts described above, that command the multi-domain language model (132) to format the output of the multi-domain language model (132) in a particular data structure. Again, an example of a general prompt is shown in FIG. 4D.

More or fewer prompts may be present in the general prompt. Generally, a general prompt may include a system message, an output instruction, and number of domain specific prompts that instruct how the different distinct sets of domain specific adapter layers of the multi-domain language model (132) should execute on a query (123A).

The data repository (100) also may store a query (123A). The query (123A) is a query upon which a primary language model (152) (defined below) is called to execute. The query may be submitted, for example, to a chatbot from one or more user devices (154) (defined below). The multi-domain language model (132), once trained, also executes on the query (123A); however, the output of the multi-domain language model (132) is a determination whether to block the query (123A) from reaching the primary language model (152).

The data repository (100) also may store an inappropriate query (123B). The inappropriate query (123B) is the query (123A). However, the label “inappropriate” may apply to the query (123A) when the multi-domain language model (132) determines that the query (123A) should be blocked. Thus, the query (123A), once determined as being a query that should be blocked, may be referred to as the inappropriate query (123B). In contrast, an “appropriate query” is a query that is not labeled as being blocked by the multi-domain language model (132).

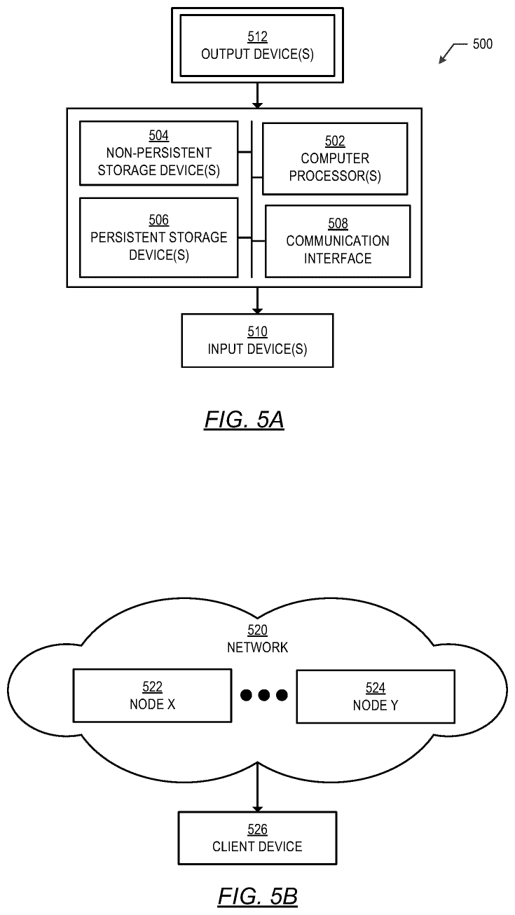

The system shown in FIG. 1A may include other components. For example, the system shown in FIG. 1A also may include a server (124). The server (124) is one or more computer processors, data repositories, communication devices, and supporting hardware and software. The server (124) may be in a distributed computing environment. The server (124) is configured to execute one or more applications, such as the server controller (128), the training controller (130), and the multi-domain language model (132). An example of a computer system and network that may form the server (124) is described with respect to FIG. 5A and FIG. 5B.

The server (124) includes a computer processor (126). The computer processor (126) is one or more hardware or virtual processors which may execute computer readable program code that defines one or more applications, such as the server controller (128), the training controller (130), and the multi-domain language model (132). An example of the computer processor (126) is described with respect to the computer processor(s) (502) of FIG. 5A.

The server (126) also may include a server controller (128). The server controller (128) is software or application specific hardware which, when executed by the computer processor (126), controls and coordinates operation of the software or application specific hardware described herein. Thus, the server controller (128) may control and coordinate execution of the language model (130), the vector generation controller (132), the mapping controller (134), and the training controller (130). Additionally, the server controller (128) may be responsible for coordinating the execution of various software components to implement the training method described with respect to FIG. 2.

The server (124) also may include a training controller (130). The training controller (130) is software or application specific hardware which, when executed by the computer processor (126), trains one or more machine learning models (e.g., the multi-domain language model (132)). The training controller (130) is described in more detail with respect to FIG. 1B.

The server (124) also includes a multi-domain language model (132). The multi-domain language model (132) is a natural language processing machine learning model that includes multiple distinct sets of layers, as defined further below with respect to the base layers (134), the domain general adapter layers (136), the first set of domain specific adapter layers (138), and the set of domain specific adapter layers (142). Each of the multiple distinct sets of layers may include multiple layers, as described further below. Use of the multi-domain language model (132) is described with respect to FIG. 2.

More specifically, the multi-domain language model (132) may be a type of a parameter efficient fine-tunable large language model with multiple sets of adapter layers, such as a multi-LoRA model (the term “LoRA” means “multiple LOW Rank Adaptations”). However, other types of language models may be used, so long as the language model being used may be separated into distinct sets of layers (e.g., the base layers (134), the domain general adapter layers (136), the first set of domain specific adapter layers (138), and the set of domain specific adapter layers (142)).

The base layers (134) are a number of layers of the multi-domain language model (132) that are inserted in between the layers. The base layers (134) may be applied to all queries to generate content moderation of all abuse categories that are common across domains (business use cases), such as toxic language.

The domain general adapter layers (136), in turn, are adapter layers that are inserted in between the base layers of the multi-domain language model (132). More specifically, the domain general adapter layers (136) are layers that are fine-tuned such that, when used as inserts to the fine-tuned base layers, lead to accurate generation of the content moderation prediction for abuse categories that are common across domains (business use cases) such as toxic language. The domain general adapter layers (136) may be a first number of low dimensional projections that are inserted into the layers of the multi-domain language model (132).

Each layer of the domain general adapter layers (136) is program code which processes an input and generates an output. The initial layer in the domain general adapter layers (136) first down-projects the outputs of the first base layer into a low dimension space and then up-projects the lower dimensional space as an input the second base layer. The output of the initial adapter layer is provided as input to a subsequent base layer in the multi-domain language model. The process of alternating input-output between the adapter and the base layers continues to repeat until the ultimate base layer generates the final output. The final output is a sequence of tokens representing the content moderation prediction of the abuse categories that are domain general (e.g., common across business use cases).

The first set of domain specific adapter layers (138) is a number of layers of the multi-domain language model (132) that, during training or inference phases, executes on the query (123A) when the query is determined to be in a first domain. The second set of domain specific adapter layers (138) may be a second number of low dimensionality projections that are inserted into the layers of the multi-domain language model (132).

The output of passing the query through the base layers interleaving with the first set of domain specific adapter layers (138) is a sequence of tokens representing the content moderation predictions for the abuse categories specific to the first domain, as described with respect to FIG. 2. In an embodiment, the output of executing the query through the base layers with the first set of domain specific adapter layers (138) may be considered in the determination to block or permit the query (123A) when the query (123A) is assigned to a first domain.

The second set of domain specific adapter layers (140) is a number of layers of the multi-domain language model (132) that, during training or inference phases, executes on the query (123A) when the query is determined to be in a second domain. The second set of domain specific adapter layers (140) may be a third number of low dimensionality projections that are inserted into the layers of the multi-domain language model (132).

The output of passing the query through the base layers interleaving with the second set of domain specific adapter layers (140) is a sequence of tokens. The sequence of tokens represent the content moderation prediction for the abuse categories in the second domain, as described with respect to FIG. 2, in determining whether to block or permit the query (123A). In an embodiment, the output of executing the query through the base layers with the second set of domain specific adapter layers (140) may be considered in the determination to block or permit the query (123A) when the query (123A) is assigned to a second domain

Additional sets of domain specific adapter layers may be present. In general, one set of domain specific adapter layers will be present for each domain to which a query may be assigned.

After training, the distinct sets of layers of the multi-domain language model (132) may be referred to as updated sets of layers. Thus, after the base layers (134) are trained, the base layers (134) become the trained base layers (142). After the domain general adapter layers (136) are trained, the domain general adapter layers (136) become the updated domain general adapter layers (144). After the first set of domain specific adapter layers (138) is trained, the first set of domain specific adapter layers (138) becomes the updated first set of domain specific adapter layers. After the second set of domain specific adapter layers (140) is trained, the second set of domain specific adapter layers (140) becomes the updated second set of domain specific adapter layers (148). Trained distinct sets of layers also may be referred to as updated distinct sets of layers.

A transformation occurs between the base layers (134) and the trained base layers (142). While the structure of the layers before and after training may be identical, the weights and parameters of the layers have been adjusted. Thus, training each set of layers changes the parameter values of the set of layers. Likewise, it may be said that training the multi-domain language model (132) transforms the multi-domain language model (132) into a different model via the iterative adjustment of the parameters to optimize the training objective.

The server (124) also may host a primary language model (152). The primary language model (152) is a language processing machine learning model (e.g., a large language model) that is trained to answer queries (e.g., the query (123A)) received from one or more user devices (154). For example, the primary language model (152) may be a generative model.

In an embodiment, there may exist multiple primary language models. For example, a number of primary language models may operate to answer queries in each of a number of different domains. For example, one primary language model may answer queries received for one domain, and another primary language model may answer queries received for a second domain. Thus, while one or more embodiments may refer to the primary language model (152), the term “the primary language model” automatically contemplates the possibility that multiple primary language models may be present.

The system shown in FIG. 1A also may include one or more user devices (154). The user devices (154) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A.

In any case, the user devices (154) are computing systems (e.g., the computing system (500) shown in FIG. 5A) that communicate with the server (124). The query (123A) may be received from one or more of the user devices (154). In another embodiment, one or more of the user devices (154) may be operated by a computer technician that services the various components of the system shown in FIG. 1A.

Attention is turned to FIG. 1B, which shows the details of the training controller (130). The training controller (130) is a training algorithm, implemented as software or application specific hardware, that may be used to train one or more of the machine learning models described with respect to the computing system of FIG. 1A.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model is applied to unknown data (i.e., data for which the actual result is not known) in order to make predictions.

In one or more embodiments, the machine learning models may be applied to text. High dimensional vectors may be more memory intensive than text. Text is natural language text, as well as possibly numbers and special characters (e.g., “*”, “!,” “@,” etc.).

However, some machine learning models may be applied to vector data structures. A vector is a computer readable data structure. A vector may take the form of a matrix, an array, a graph, or some other data structure. However, a frequently used vector form is a one by N matrix, where each cell of the matrix represents the value for one feature. As described above, a feature is a topic of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In one or more embodiments, some of the data in the data repository (100) of FIG. 1A may be stored in the form of one or more vectors. For example, the domain general labeled dataset (110), the first domain specific labeled dataset (112), and the second domain specific labeled dataset (114) may be expressed as vectors. Similarly, the first prompt (118), the second prompt (120), and third prompt (122) may be converted from natural language into vectors as part of executing the multi-domain language model (132) according to the instructions in the first prompt (118), the second prompt (120), and the third prompt (122).

Returning to the operation of the training controller (130), training starts with training data (176), which may be expressed in vector form. The training data (176) may be the domain general labeled dataset (110), the domain general labeled dataset (110), and the domain specific labeled dataset (106) from FIG. 1A, expressed in vector form.

The training data is labeled. The labels represent a known result. Thus, a label applied to a query in the domain general labeled dataset (110) may be a structured text containing the content moderation labels for the different abuse categories.

Thus, the training data (176) may be data for which the final result is known. The final result may be represented as a structured text that specifies whether the query belongs to any abuse categories. For example, when the multi-domain language model (132) is called during training to predict whether a query (123A) present in the domain general labeled dataset (110) contains any abuse among the domain general abuse categories (152), the multi-domain language model (132) generates the prediction as structured text. If the prediction does not match the label, then the parameter values of the layers in the first set of domain specific adapter layers (138) may be updated and the training process iterated.

More generally, the training data (176) is provided as input to the machine learning model (178), which may be the multi-domain language model (132) of FIG. 1A. The machine learning model (178) may be characterized as a program that has adjustable parameters. The program is capable of learning and recognizing patterns to make predictions. The output of the machine learning model (178) may be changed by changing one or more parameters of the algorithm, such as the parameter (180) of the machine learning model (178). The parameter (180) may be one or more weights, the application of a sigmoid function, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a predetermined end condition of training has been reached. The predetermined end condition may vary based on the type of training objectives being used (supervised versus unsupervised machine learning), or may be predetermined by a user (e.g., convergence occurs after a set number of training iterations, described below).

In the case of supervised machine learning (e.g., the trained supervised machine learning model (144) of FIG. 1A), the convergence process (184) compares the output (182) to a known result (186). The known result (186) is stored in the form of labels for the training data (176). For example, the known result (186) for a particular entry in an output (182) of the machine learning model (178) may be a known value, and that known value is a label that is associated with the training data (176).

Continuing the example of supervised machine learning model training, a determination is made whether the output (182) matches the known result (186) to a predetermined degree. The predetermined degree may be an exact match, a match to within a pre-specified percentage, or some other metric for evaluating how closely the output (182) matches the known result (186). Convergence may occur when the known result (186) matches the output (182) to within a pre-specified percentage. When many predictions are involved (e.g., the training data (176) includes the domain general labeled dataset (110), and the domain specific labeled dataset (106), each of which contains numerous queries), then convergence may be determined based on the match results aggregated across the data instances.

For example, the threshold may be 95%. In this case, when the multi-domain language model (132) accuracy reaches 95% (representing that in 95% out of all tokens across all data points exactly match the labels), then convergence occurs.

In the case of unsupervised machine learning, the convergence process (184) may be compared to the output (182) or to a prior output in order to determine a degree to which the current output changed relative to the immediately prior output or to the original output. Once the degree of improvement in model predictions fails to satisfy the threshold degree of change, then the machine learning model may be considered to have achieved convergence. Alternatively, an unsupervised model may use alternatives (such as similarity measures, sequence of next tokens or other patterns in the data) to determine whether a training achieves convergence as described above for a supervised machine learning model.

If convergence has not occurred (a “no” at the convergence process (184)), then a loss function (188) is generated. The loss function (188) is a program that specifies the method for which to compare the model prediction and the labels. The optimization function takes the loss as an input then determines the degree to which each tunable parameters in the model should be adjusted according to the loss and the degree to which each parameter contributes to the prediction. The basis for performing the adjustment is defined by the optimizer. The program may be an algorithm which attempts to estimate how the parameter (180) may be changed in the direction toward improving the overall quality of the predictions so that the next execution of the machine learning model (178), using the training data (176) with the updated parameter (190), will have an output (182) that is more likely to result in convergence. In this manner, the next execution of the machine learning model (178) is more likely to match the known result (186) (supervised learning), or which is more likely to result in an output (182) that more closely approximates the prior output (one unsupervised learning technique), or which otherwise is more likely to result in convergence.

In any case, the optimization function is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data for which the final result is not known. The output of the trained machine learning model (192) is then treated as a prediction of the information of interest relative to the unknown data.

While FIG. 1A and FIG. 1B shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for training a multi-domain language model for content moderation, in accordance with one or more embodiments. The method of FIG. 2 may be implemented using the system of FIG. 1A and FIG. 1B. One or more of the steps may be performed on or received at one or more computer processors. In an embodiment, a system may include at least one processor and an application that, when executing on at least one processor, performs the method. In an embodiment, a non-transitory computer readable medium may include instructions that, when executed by one or more processors, perform the method. The outputs from various components (including models, functions, procedures, programs, processors, etc.) performing the method may be generated by applying a transformation of inputs using the components to create the outputs without using mental processes or human activities.

Step 200 includes receiving a multi-domain language model. Receiving may include a number of different actions. For example, receiving may include loading a multi-domain language model into memory in order that a processor may execute computer readable instructions with respect to the multi-domain language model. Receiving may include receiving, or retrieving, the multi-domain language model from a local data source or a remote data source. In any case, as defined above with respect to FIG. 1A, the multi-domain language model may include a number of base layers, a number of domain general adapter layers, and one or more sets of domain specific adapter layers.

Step 202 includes training, to generate an updated number of base layers, the base layers on an unlabeled training dataset. Training the base layers may be performed as described with respect to the general training process presented in FIG. 1B. However, the base layers are trained during step 202. In an embodiment, the complete available unlabeled training dataset may be used while training the base layers. During the base layers training, the unlabeled data is passed through only the base layers, and the parameters of the base layers are updated.

In an embodiment, step 202 is performed before performing step 204 or step 206. In other words, when performing step 204 or step 206, the base layers are already transformed into the trained base layers. However, step 202 also may be performed serially, as step 202, step 204, and step 206 are independent.

Step 204 includes training, to generate an updated number of domain general adapter layers, the domain general adapter layers on a domain general labeled dataset generated from the unlabeled training dataset. Updating the domain general adapter layers excludes updating the set of domain specific adapter layers and further excludes updating the base layers.

Training the domain general adapter layers may be performed as described with respect to the general training process presented in FIG. 1B. However, the domain general adapter layers are trained during step 204. In an embodiment, the distinct sets of layers other than the domain general adapter layers are frozen (i.e., excluded from the training process) while the domain general adapter layers are being trained. Furthermore, training of the domain general adapter layers may proceed using the domain general labeled dataset, to the exclusion of the domain specific datasets.

However, training of the domain general adapter layers still includes application of the trained base layers during the training process. In other words, while training, the trained base layers and the domain general adapter layers of the multi-domain language model execute on the domain general labeled dataset according to the second prompt in order to generate the intermediate prediction. Note, however, that the trained base layers remain frozen (are not updated) even though the trained base layers process the training data. Thus, training the domain general adapter layers may be characterized as passing the domain general labeled dataset through the trained base layers and the domain general adapter layers, but only the domain general adapter layers are updated during training. Other sets of layers (including the sets of domain specific adapter layers) are not updated during step 204.

Step 206 includes training, to generate an updated set of domain specific adapter layers, the set of domain specific adapter layers on a domain specific labeled dataset generated from the unlabeled training dataset. Updating the set of domain specific adapter layers excludes updating the domain general adapter layers, and further excludes updating any other sets of domain specific adapter layers that may be present.

Training the set of domain specific adapter layers may be performed as described with respect to the general training process presented in FIG. 1B. However, the second domain layers of the set of domain specific adapter layers are trained during step 206. In an embodiment, the distinct sets of layers other than the set of domain specific adapter layers are frozen (i.e., excluded from the training process) while the set of domain specific adapter layers is trained. Furthermore, training of the set of domain specific adapter layers may proceed using the domain specific labeled dataset, to the exclusion of the general domain dataset and other domain specific labeled datasets.

However, training of the set of domain specific adapter layers still includes application of the trained base layers when performing the intermediate prediction during the training process. In other words, while training, the trained base layers and the set of domain specific adapter layers of the multi-domain language model execute on the domain specific labeled dataset according to the second prompt in order to generate the intermediate prediction. Thus, training the set of domain specific adapter layers may be characterized as passing the domain specific labeled dataset through the trained base layers and the set of domain specific adapter layers. However, only the set of domain specific adapter layers being trained are updated at step 206.

Step 208 includes returning, as a trained multi-domain language model, the updated base layers, the updated domain general adapter layers, and the updated set of domain specific adapter layers. Returning may be performed by storing the trained multi-domain language model. Returning may be performed by providing the trained multi-domain language model for use during an inference phase when the trained multi-domain language model is applied to new (i.e. unknown) queries. Returning may be performed by providing the trained multi-domain language model to some other computing process. In an embodiment, the method of FIG. 2 may terminate thereafter.

As a result of training, the trained multi-domain language model is configured to generate a prediction in the term of structured text that specifies whether the query contains any abuse categories. The output of the trained multi-domain language model may be in a format as specified by an output prompt (see FIG. 4D).

In use, during a prediction made during either training or at inference, the outputs of passing the query through the base layer with interleaving the domain general and domain specific sets of layers may be linearly combined. In an embodiment, each of the distinct sets of layers are applied to a query regardless of the domain to which the query is assigned. However, the output of the domain distinct sets of layers to which the query was not assigned are multiplied by zero. In this manner, the output of model distinct sets of layers outside of the selected domains are not considered in the final result. Thus, the final output of the multi-domain language model for a query in a specified domain is a combination of the output of passing the query through the base layers with interleaving domain general adapter layers and the base layers with interleaving selected set of domain specific adapter layers (i.e., the set of domain specific adapter layers to which the query was assigned), to the exclusion of the any other sets of domain specific adapter layers.

The combined output may be a structured text presenting the content moderation predictions which specifies whether the queries contain any abuse categories (domain general and selected domain specific). The structure text contains the probability of presence of abuse for each abuse categories. When the abuse probability for any of the domain general and selected domain specific categories exceeds the corresponding threshold for each category, then the content moderation action is to block the query. The output, again, may be formatted according to the prompt provided to the multi-domain language model.

In view of the above, it may be said that the base layers are trained to adapt to natural language queries to be moderated. The domain general adapter layers are trained to generate content moderation prediction for abuse categories that are common across business use cases (domains), when executed according to a first prompt among the prompts submitted to the large language model. The first set of domain specific adapter layers is trained to generate content moderation prediction for the abuse categories that are specific to the first domain specific business use case, when executed according to a second prompt among the prompts submitted to the large language model. The domain general adapter layers are excluded from executing on the second prompt. The first set of domain specific adapter layers is excluded from executing on the first prompt.

In view of the above, it may be said that the base layers are trained to identify, when executed, whether prompts submitted to a large language model are permissible or impermissible (i.e., permitted or blocked). The domain general adapter layers is trained to identify, when executed according to a first prompt among the prompts submitted to the large language model, whether a query is permissible or impermissible when the query is assigned to a general domain. The first set of domain specific adapter layers is trained to identify, when executed according to a second prompt among the prompts submitted to the large language model, whether a query is permissible or impermissible when the query is assigned to a first domain. The domain general adapter layers are excluded from executing on the second prompt. The first set of domain specific adapter layers is excluded from executing on the first prompt.

The method of FIG. 2 may be varied. For example, as mentioned above, training the base layers may be performed prior to training the domain general adapter layers and the sets of domain specific adapter layers. However, training the domain general adapter layers and the sets of domain specific adapter layers may be performed in parallel, or serially, after training the base layers.

In another example, the method of FIG. 2 also may include generating the domain general labeled dataset, and the domain specific labeled dataset from an unlabeled dataset. Generating the datasets may be performed by automatically generating labels for an unlabeled dataset and applying the labels to the unlabeled dataset, as described below.

For example, generating the datasets may include applying, to generate a general labeled dataset, a large language model to an unlabeled dataset. Applying is performed according to a first prompt that instructs the large language model to identify unlabeled data in the unlabeled dataset as assigned to the domain general dataset when the unlabeled data is not assigned any labels. However, additional labeled data (e.g., general data from a low confidence dataset after manual labels are applied) may be added to the general labeled dataset to generate the overall general domain dataset. Still other data may be added to the general labeled dataset as part of forming the general domain dataset.

Similarly, generating the datasets may include applying, to generate a first domain specific labeled dataset, the large language model to the unlabeled dataset. Applying is performed according to a second prompt, different from the first prompt that instructs the label generating large language model to generate domain specific labels to unlabeled data in the unlabeled dataset as belonging to the corresponding domain specific labeled dataset. The domain specific labeled dataset is thereby generated from unlabeled training dataset. As described above, additional labeled data (e.g., first domain data from a low confidence dataset after manual labels are applied) may be added to the first domain specific labeled dataset to generate the overall domain specific labeled dataset. Still other data may be added to the first domain specific labeled dataset as part of forming the domain specific labeled dataset. A similar procedure may be applied to generate other domain specific labeled datasets, such as the second domain specific labeled dataset.

Other variations of the method of FIG. 2 are possible. For example, the method also may include identifying a low confidence data subset from the general labeled dataset, the first domain specific labeled dataset, and the second domain specific labeled dataset. In this case, the method also may include receiving a new high confidence label for the low confidence data subset to generate a new labeled data subset. Then, the new labeled data subset is assigned to one of the general labeled dataset, the first domain specific labeled dataset, and the second domain specific labeled dataset. Assigning is performed as part of performing at least one of: i) gathering unlabeled dataset, ii) generating the domain general labeled dataset, or iii) generating the domain specific labeled dataset.

In another variation, the method of FIG. 2 may include receiving a prompt that includes a query. In this case, the method also includes identifying a domain type of the prompt as belonging to the set of domain specific adapter layers. Then, the trained multi-domain language model is applied to the prompt. Applying further includes excluding the domain general adapter layers and including the set of domain specific adapter layers during application of the trained multi-domain language model to the prompt.

The method of FIG. 2 is not limited to the English language. In an embodiment, the general domain dataset, the domain general labeled dataset, and the domain specific labeled dataset may include queries made in multiple different languages. Thus, for example, the multi-domain language model may be trained to perform content moderation for multiple languages. Queries in each language may be designated as belonging to a different domain (e.g., an English domain, a Spanish domain, a French domain, etc.).

While the various steps in this flowchart are presented and described sequentially, at least some of the steps may be executed in different orders, may be combined or omitted, and at least some of the steps may be executed in parallel. Furthermore, the steps may be performed actively or passively.

FIG. 3 through FIG. 4D shows an example of training a multi-domain language model for content moderation, in accordance with one or more embodiments. The following example is for explanatory purposes only and not intended to limit the scope of one or more embodiments.

Specifically, FIG. 3 shows an architecture and data flow for generating a training dataset for training a multi-domain language model for content moderation, in accordance with one or more embodiments. FIG. 4A and FIG. 4B shows an architecture for training a multi-domain language model, in accordance with one or more embodiments. FIG. 4C shows a data flow for training a multi-domain language model, in accordance with one or more embodiments. FIG. 4D shows an example of a prompt usable during training or inference of a multi-domain language model, in accordance with one or more embodiments.

Attention is first turned to FIG. 3, which shows an architecture and data flow for generating a training dataset for training a multi-domain language model for content moderation, in accordance with one or more embodiments. The training data generation process of FIG. 3 proceeds in two phases. The first phase (300) is a labeling phase. The second phase (302) is a data augmentation and enrichment phase.

In an embodiment a golden dataset (304) is already available during the first phase (300). The golden dataset (304) is a term used to refer to a dataset that is, in an initial form, suitable for use as training data. Here, the golden dataset (304) includes queries and labels assigned to the queries. The labels are structured texts that contains content moderation ground truths for different abuse categories. Because the golden dataset (304) is already labeled, the golden dataset (304) is passed to the second phase (302).

However, the golden dataset (304) may not be sufficient data. Machine learning may rely on a large amount of training data in order to generate a trained multi-domain language model capable of performing content moderation for the particular industry in different business use cases (domains) to a desired level of accuracy. A “large” amount of data varies depending on a particular implementation, but generally obtaining as much training data that captures the query variations present in realistic business use cases. However, for the purposes of one or more embodiments, the term “large amount of data” refers to an amount of data (i.e. queries) which, when used to train a multi-domain language model according the method of FIG. 2, results in a trained multi-domain language model that is sufficiently accurate to a predetermined degree for the realistic business use cases.

Because the golden dataset (304) may not cover the query variations in the production data from realistic business use cases, additional labeled data may be added to the golden dataset (304). In an embodiment, the organizing, owning, and operating the system of FIG. 1A and FIG. 1B, and the method of FIG. 2, may have a large amount of production data (306). The production data (306) is queries to one or more chatbots and responses generated by the one or more chatbots in response to the queries.

However, the production data (306) is not labeled. In other words, while many queries and responses are available, it is not known whether the queries are permitted queries or inappropriate queries. Nevertheless, one or more embodiments provide for a method of generating labels for the production data (306).

Specifically, the production data (306) is provided as input to a large language model (308). The large language model (308) may be some other language model (e.g., CHATGPT®). Each query (and possibly each corresponding response) in the production data (306) is provided as input to the large language model (308). A prompt instructs the large language model (308) to generate a label for each of the queries in the production data (306). The label may be the structured text containing the content moderation labels for each abuse categories.

A confidence model may be applied to the outputs of the large language model (308). The confidence model determines a confidence score for each of the labels generated by the large language model (308). Alternatively, the confidence scores maybe derived from the outputs of the large language model (308) itself (i.e., the prompt instructs the large language model (308) to estimate a likelihood that the output label is correct). The confidence model may be some other machine learning model that monitors the performance of the large language model (308).

Labels having a high confidence score (i.e., high confidence labels) are automatically assigned to the corresponding queries. The term “high confidence score” refers to a score that exceeds an upper threshold predetermined number. The queries with automatically assigned labels (310) are ready for the second stage (302).

However, labels having a low confidence score (i.e., low confidence labels) are provided to computing devices operated by human technicians (i.e., human labelers (312)). The term “low confidence score” refers to a score that is below a lower threshold predetermined number (e.g., below the upper threshold predetermined number). The human labelers use the user devices to verify or revise the labels generated by the large language model (308). Thus, queries with human assigned labels (314) are ready for the second phase (302).

Turning to the second phase (302), the queries with human assigned labels (314) and the queries with automatically assigned labels (310) are combined and referred to as labeled data (316). The labeled data (316) is added to the golden dataset (304) to form the complete training dataset.

The complete training dataset is provided to a domain assignment process (318). The domain assignment process (318) assigns each label to a corresponding domain from among a number of pre-determined domains. In this manner, each label is a subset of the complete training dataset, and each query have multiple labels, one for each domain.

Then, the data subsets may be subject to a split process (320). During the split process (320), the complete training dataset is split into the domain datasets. In other words, the complete training dataset is grouped or stored into a general domain dataset, a domain general labeled dataset, a domain specific labeled dataset, etc.

Optionally, the specific datasets generated after the split process (320), may be further augmented during an augment process (322). The augment process (322) may add additional queries and labels to the golden dataset (304) and the labeled data (316). For example, queries and labels in different languages may be added to the training data. Again optionally, the different languages may be translated into a single language (e.g., English) during a translate process (324). Thus, training of the multi-domain language model may proceed in a single language, in an embodiment, or may proceed in multiple languages in another embodiment.

Thereafter, the final training dataset (326) is available. The final training dataset (326) may be stored, and thereafter used to train the multi-domain language model (132) of FIG. 1A according to the method of FIG. 2.

FIG. 4A and FIG. 4B shows an architecture for training a multi-domain language model, in accordance with one or more embodiments. In particular, FIG. 4A shows a first training phase of a multi-domain language model, such as the multi-domain language model (132) of FIG. 1A. In FIG. 4A, a multi-domain language model is trained. In one example, the language model may be a LLaMA Guard large language model. LLaMA Guard is a type of large language model which may be used for content moderation of a primary large language model. However, the multi-domain language model shown in FIG. 4A (and in FIG. 4B) may be other types of multi-domain language models.

FIG. 4B shows a second training phase of training the multi-domain language model. During the second training phase, the different adapter layers a multi-domain language model (410) is trained. The multi-domain language model (410) in the example is a generative language model with multi-LoRA layers (LoRA stands for “Low Rank Adaptations”). The base of the multi-domain language model (410) is the trained LLaMA Guard (406), trained as described with respect to FIG. 4A. However, during the second training phase, only the additional domain distinct sets of adapter layers are trained. Thus, after training, the multi-domain language model (410) may be composed of the trained base layers (142), the updated domain general adapter layers (148), and the updated first set of domain specific adapter layers (150), as described with respect to FIG. 1A.

In the first training phase (400) of FIG. 4A, a unlabeled dataset (402) is used to train the base layers of a LLaMA Guard model (404). The training proceeds as described with respect to FIG. 1B and step 202 of FIG. 2. The result of training is the trained LLaMA Guard base layers (406).

FIG. 4B shows a second training phase (408), which corresponds to step 204 and step 206 of FIG. 2. During the second training phase (408), a multi-domain language model (410) is trained after training the trained base layers (406). In fact, the base layers (412) in FIG. 4B compose the trained base layers (406) from FIG. 4A.

Additionally, the multi-domain language model (410) includes a number of specific distinct sets of adapter layers, including domain general adapter layers (414), a first set of domain specific adapter layers (416), and a second set of domain specific adapter layers (418). As shown in FIG. 4B, each set of domain specific adapter layers includes multiple layers of the multi-domain language model (410). The sets of domain specific adapter layers are used when processing domain-specific queries stored in training datasets (420).

The multi-domain language model (410) is trained using a number of training datasets (420), composed of queries to a primary large language model. The primary large language model in the example is a chatbot owned and operated by the organization that controls the multi-domain language model (410). The organization desires to moderate the output of the primary large language model by, using the multi-domain language model (410), blocking inappropriate queries to the large language model, but permitting appropriate queries to the primary large language model.

In the example of FIG. 4B, each domain represents a different software program operated by a business. During an inference phase, queries to a primary language model are received from each of three different software programs. However, different prompts to the multi-domain language model (410) may be used when applying the multi-domain language model (410) to the queries, depending on the domain to which a query is assigned. Therefore, each of the domain distinct sets of layers (i.e., the domain general adapter layers (414), the first set of domain specific adapter layers (416), and the second set of domain specific adapter layers (418)) is to be trained specifically on queries submitted to the respective domain.

Accordingly, the training datasets (420) include a domain general labeled dataset including queries falling into a general domain (e.g., the domain general labeled dataset (110) of FIG. 1A). The training datasets (420) also include a domain specific labeled dataset including queries falling into a first domain (e.g., the first domain specific labeled dataset (112) of FIG. 1A). The training datasets (420) also include a third domain dataset including queries falling into a second domain (e.g., the second domain specific labeled dataset (114) of FIG. 1A).

Each of the queries in the training datasets (420) is labeled with a corresponding label that indicates the correct prediction for the corresponding query. Thus, for example, a given query in the training datasets (420) may be provided with a label that indicates whether the query contains abusive content based on the different abuse categories.

The second training phase (408) is now described in detail with respect to training architecture (422) of the multi-domain language model (410). A snowflake symbol (e.g., snowflake (424)) shows that a set of layers is frozen, meaning that the frozen distinct sets of layers are not being updated during training. A fire symbol (e.g., flame (426)) shows that a set of layers is being trained, meaning that the weights and parameters of the set of layers under training may be updated during the iterative training process.

In the training architecture (422), only the first set of domain specific adapter layers (416) is being trained. Thus, the layer input (428) represents those queries in the training datasets (420) that fall within the first domain.

During training, as described with respect to FIG. 1B, the multi-domain language model (410) generates a prediction (the layer output (426)) when applied to a query in the training datasets (420). When generating the prediction, the base layers (412) and the first set of domain specific adapter layers (416) are applied to the query. The domain general adapter layers (414) and the second set of domain specific adapter layers (418) also may be applied to the query. However, the output of the domain general adapter layers (414) and the output of the second set of domain specific adapter layers (418) (i.e., non-selected domain distinct sets of layers) are multiplied by zero at a LoRA output stage (430). The LoRA output stage is the point at which the outputs of each set of layers of the multi-domain language model (410) is generated.

The final output of the multi-domain language model (410) is a combination of the outputs of the various distinct sets of layers of the LoRA output stage (430). For example, the non-zero outputs of the LoRA output stage (430) may be multiplied or combined in some other fashion. In this manner, during training, the non-selected domain distinct sets of layers (i.e., the domain general adapter layers (414) and the second set of domain specific adapter layers (418) in the example) will not influence the training of the selected set of domain specific adapter layers (i.e., the first set of domain specific adapter layers (416)).

Training then proceeds as described with respect to FIG. 1B, but only the weights and parameters of the first set of domain specific adapter layers (416) are updated. Thus, more specifically, the prediction for the query described above is compared to the label for the query. If the prediction is incorrect, then a loss function is generated and the weights and parameters of the first set of domain specific adapter layers (416) are adjusted according to the loss function. Alternatively, predictions of all the queries in the domain specific labeled dataset are generated and the predictions compared to the labels for the queries that compose the domain specific labeled dataset. In this case, a different loss function is generated according to a total percentage of incorrect predictions. The weights and parameters of the first set of domain specific adapter layers (416) may be updated according to the different loss function.

As described with respect to training generally, the training of the first set of domain specific adapter layers (416) is an iterative process. Once the weights and parameters of the first set of domain specific adapter layers (416) are updated, then the queries in the domain specific labeled dataset are again submitted to the intermediate version of the multi-domain language model (410) to generate new predictions. The new predictions are then compared to the labels and a new loss function generated accordingly, as described above. The new loss function is used to again adjust the weights and parameters of the first set of domain specific adapter layers (416). The process continues iteratively until convergence of the first set of domain specific adapter layers (416).

A similar process is repeated with respect to the domain general adapter layers (414). However, during training of the domain general adapter layers (414), the first set of domain specific adapter layers (416), the second set of domain specific adapter layers (418), and the base layers (412) are frozen and the domain general adapter layers (414) is trained.

Likewise, a similar process is repeated with respect to the second set of domain specific adapter layers (418). However, during training of the second set of domain specific adapter layers (418), the base layers (412), the domain general adapter layers (414), and the first set of domain specific adapter layers (416) are frozen and the second set of domain specific adapter layers (418) is trained.

Training of the three domain distinct sets of layers may be performed in parallel. In other words, different versions of the multi-domain language model (410) are executed on different machines, with each machine training one of the domain distinct sets of layers. Thereafter, the trained versions of the domain distinct sets of layers may be combined with the base layers (412) (again, trained in the first training phase in FIG. 4A). The combination may be accomplished by directly altering the weights and parameters of each of the domain distinct sets of layers to match to the results of the respective training procedures for each of the domain distinct sets of layers.

Alternatively, training of the three domain distinct sets of layers may be performed serially. In other words, each of the domain distinct sets of layers is trained in turn until convergence is achieved for each of the three domain distinct sets of layers.

FIG. 4C shows a data flow for training a multi-domain language model, in accordance with one or more embodiments. The data flow of FIG. 4C may be applied to the training architecture of FIG. 4A and FIG. 4B. Thus, FIG. 4C represents a specific implementation of a method for training a multi-domain language model, as described with respect to FIG. 2.

Training begins with an initial model (450). The initial model (450) may be the multi-domain language model (132) of FIG. 1A or the multi-domain language model (410) of FIG. 4B, prior to the first training phase.

First, a training controller trains the base layers at step (452). Training the base layers at step (452) corresponds to the first training phase in FIG. 4A. The base layers may be trained using an unlabeled dataset (455). The result of step (452) is a first trained language model (458). The first trained language model (458) corresponds to the trained base layers (406) in FIG. 4A.

Next, the training controller trains the domain general adapter layers at step 459. Step 459 corresponds to training the domain general adapter layers (414) in FIG. 4B. As a result, the domain general adapter layers are trained.

Next, the training controller selects the next domain specific set of layers at step (460). Step (460) corresponds to the selection of the first set of domain specific adapter layers (416) for training in FIG. 4B. Then the training controller trains the selected domain specific set of layers at step (462), as described with respect to FIG. 4B. Specifically, the selected set of domain specific adapter layers (462) is trained on a corresponding domain specific dataset. Thus, if the selected set of layers is an “N^{th}” set of domain specific adapter layers, then an N^{th} domain specific dataset (466) is used to train the selected set of domain specific adapter layers. The result of training at step (462) is a trained set of domain specific adapter layers (468).

Then a determination is made at step (470) whether additional sets of domain specific adapter layers are to be trained. If “yes,” then the process returns to step (460) and repeats. If “no,” then the sets of domain specific adapter layers are considered trained. The iterative process between step (460) and the decision at step (470) may be performed in parallel for each domain specific set of layers. The training of the domain general adapter layers at step 459 also may be performed in parallel with the training of the sets of domain specific adapter layers.

When training is complete, the trained sets of domain specific adapter layers, the trained general adapter layers, and the first trained language model (458) may be combined into a trained model (472). Alternatively, the process could have been performed serially, in which case the trained model (742) would result after the last domain specific set of layers had been trained.

FIG. 4D shows an example of a prompt (480) usable during training or inference of a multi-domain language model, in accordance with one or more embodiments. The prompt (480) may be used during the training of the multi-domain language model (132) described with respect to FIG. 1A or the multi-domain language model (410) described with respect to FIG. 4B. The prompt (480) also may be used during an inference phase after the training process. In other words, the prompt (480) may be used when applying a multi-domain language model to an unknown query submitted to a primary language model in order to generate a content moderation prediction that can be used to determine whether the unknown query should be blocked or permitted.

The prompt includes five sections. A system message (482) provides general instructions to the multi-domain language model, as shown. The system message (482) may limit how the language model determines the output of “block” or “permit.”

A domain general instruction (484) instructs the multi-domain language model regarding general harms that may apply to each of the domain distinct sets of layers in the multi-domain language model. Domain general harms may include prompt injection attacks, profanity, toxic messages, etc. The domain general instruction (484) may limit how domain general adapter layers are applied to generate the generate content moderation prediction that can be used to determine whether to “block” or “permit.”

A domain specific instruction (486) instructs the multi-domain language model regarding specific harms that may apply to one of the sets of domain specific adapter layers in the multi-domain language model, but not necessarily other sets of domain specific adapter layers in the multi-domain language model. Domain specific harms may include queries that are off-topic (e.g., a tax question submitted to marketing software), or may include queries related to prohibited advice for the domain (e.g., asking for legal advice that only a licensed lawyer could give).

Additional domain specific instructions also may be present. In an embodiment, one set of domain specific instructions is present for each set of domain specific adapter layers.

A content section (488) contains the content to be moderated (i.e., the content for which the prediction will be performed). For example, the content section (488) may contain the queries for which content moderation predictions are based on (i.e., the content is the queries). The content section (488) may also reference a database from which the language model may retrieve the content to be moderated.

An output structure instruction (490) instructs the multi-domain language model regarding how the multi-domain language model should return the final output (i.e., the prediction for the query). As shown, the output may be presented in a structured object notation data file (e.g. a JSON file (JSON stands for JAVASCRIPT® object notation)). The relative harm represented by the query may be represented by a number between 1 and 10. An example input and an example output are provided in the output structure instruction (490) so that the multi-domain language model may return other predictions in a similar manner.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication set of layers between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a multi-domain language model, comprising:
a plurality of base layers,
a plurality of domain general adapter layers, and
a set of domain specific adapter layers;
training, to generate an updated plurality of base layers, the plurality of base layers on an unlabeled training dataset;
training, to generate an updated plurality of domain general adapter layers, the plurality of domain general adapter layers on a domain general labeled dataset generated from the unlabeled training dataset,
wherein training the plurality of domain general adapter layers excludes updating the set of domain specific adapter layers;
training, to generate an updated set of domain specific adapter layers, the set of domain specific adapter layers on a domain specific labeled dataset generated from the unlabeled training dataset,
wherein training the set of domain specific adapter layers excludes updating the plurality of domain general adapter layers; and
returning, as a trained multi-domain language model, the updated plurality of base layers, the updated plurality of domain general adapter layers, and the updated set of domain specific adapter layers.

2. The method of claim 1, wherein training the plurality of domain general adapter layers further comprises passing the domain general labeled dataset through the updated plurality of base layers and the plurality of domain general adapter layers.

3. The method of claim 1, wherein training the set of domain specific adapter layers further comprises passing the domain specific labeled dataset through the updated plurality of domain general adapter layers and the set of domain specific adapter layers.

4. The method of claim 1, wherein training the plurality of domain general adapter layers and the set of domain specific adapter layers are performed independently and in parallel.

5. The method of claim 1, wherein:
training the plurality of base layers is performed prior to training the plurality of domain general adapter layers and prior to training the set of domain specific adapter layers, and
training the plurality of domain general adapter layers and the set of domain specific adapter layers are performed in parallel after the training of the plurality of base layers.

6. The method of claim 1, further comprising:
generating the domain general labeled dataset and the domain specific labeled dataset from the unlabeled training dataset.

7. The method of claim 1, further comprising:
applying, to generate the domain general labeled dataset, a large language model to the unlabeled training dataset, wherein applying is performed according to a prompt that instructs the large language model to identify a subset of unlabeled data in the unlabeled training dataset as assigned to the domain general labeled dataset; and
generating the domain general labeled dataset by applying domain general labels to the subset of unlabeled data.

8. The method of claim 1, further comprising:
applying, to generate the domain specific labeled dataset, a large language model to the unlabeled training dataset, wherein applying is performed according to a prompt that instructs the large language model to identify a subset of unlabeled data in the unlabeled training dataset as assigned to the domain specific labeled dataset; and
generating the domain specific labeled dataset by applying domain specific labels to the subset of unlabeled data.

9. The method of claim 1, further comprising:
applying, to generate a second domain specific labeled dataset, a large language model to the unlabeled training dataset, wherein applying is performed according to a prompt that instructs the large language model to identify a second subset of unlabeled data in the unlabeled training dataset as assigned to the second domain specific labeled dataset;
generating the second domain specific labeled dataset by applying second domain specific labels to the second subset of unlabeled data;
training, to generate an updated second set of domain specific adapter layers, a second set of domain specific adapter layers on the second domain specific labeled dataset,
wherein training the second set of domain specific adapter layers excludes updating the plurality of domain general adapter layers, and
wherein training the second set of domain specific adapter layers excludes updating the set of domain specific adapter layers; and
returning further comprises returning, as part of the trained multi-domain language model, the updated second set of domain specific adapter layers.

10. The method of claim 9, wherein the domain general labeled dataset, the first domain specific labeled dataset, and the second domain specific labeled dataset comprise a plurality of different languages.

11. The method of claim 1, further comprising:
applying, to generate the domain general labeled dataset, a large language model to the unlabeled training dataset, wherein applying is performed according to a prompt that instructs the large language model to identify a subset of unlabeled data in the unlabeled training dataset as assigned to the domain general labeled dataset;
generating the domain general labeled dataset by applying domain general labels to the subset of unlabeled data;
applying, to generate the domain specific labeled dataset, a large language model to the unlabeled training dataset, wherein applying is performed according to a prompt that instructs the large language model to identify a subset of unlabeled data in the unlabeled training dataset as assigned to the domain specific labeled dataset;
generating the domain specific labeled dataset by applying domain specific labels to the subset of unlabeled data;
applying, to generate a second domain specific labeled dataset, a large language model to the unlabeled training dataset, wherein applying is performed according to a prompt that instructs the large language model to identify a second subset of unlabeled data in the unlabeled training dataset as assigned to the second domain specific labeled dataset; and
generating the second domain specific labeled dataset by applying second domain specific labels to the second subset of unlabeled data.

12. The method of claim 11, further comprising:
identifying a low confidence data subset from the domain general labeled dataset, the first domain specific labeled dataset, and the second domain specific labeled dataset;
receiving a new label for the low confidence data subset to generate a new labeled data subset; and
assigning the new labeled data subset to one of the general labeled dataset, the first domain specific labeled dataset, and the second domain specific labeled dataset, wherein assigning is performed as part of performing at least one of: i) generating the domain general labeled dataset, ii) generating the first domain specific labeled dataset, or iii) generating the second domain specific labeled dataset.

13. The method of claim 1, wherein:
the updated plurality of domain general adapter layers is trained to identify, when executed, whether a plurality of prompts submitted to a large language model are permissible or impermissible,
the updated set of domain specific adapter layers is trained to identify, when executed, whether a first prompt in the plurality of prompts submitted to the large language model is permissible or impermissible when the first prompt is assigned to a first domain, and
a second updated set of domain specific adapter layers of the multi-domain language model is excluded from executing on the first prompt.

14. The method of claim 1, further comprising:
receiving a prompt;
identifying a domain type of the prompt as belonging to the set of domain specific adapter layers; and
applying the trained multi-domain language model to the prompt, wherein applying further includes only executing the updated plurality of base layers, the updated plurality of domain general adapter layers, and the updated set of domain specific adapter layers during application of the trained multi-domain language model to the prompt.

15. A system comprising:
a processor;
a data repository in communication with the processor and storing:
an unlabeled training dataset,
a domain general labeled dataset generated from the unlabeled training dataset, and
a domain specific labeled dataset generated from the unlabeled training dataset;
a multi-domain language model comprising a plurality of base layers, a plurality of domain general adapter layers, and a set of domain specific adapter layers, wherein:
the plurality of base layers comprises a plurality of layers of the multi-domain language model,
the plurality of domain general adapter layers comprises a first plurality of low dimensional projections that are inserted into the plurality of layers of the multi-domain language model, and
the set of domain specific adapter layers comprises a second plurality of low dimensionality projections that are inserted into the plurality of layers of the multi-domain language model;
a training controller which, when executed by the processor is configured to:
train the plurality of base layers on the unlabeled training dataset to generate an updated plurality of base layers,
train the plurality of domain general adapter layers on the domain general labeled dataset to generate an updated plurality of domain general adapter layers,
train the set of domain specific adapter layers on the domain specific labeled dataset to generate an updated set of domain specific adapter layers, and
return, as a trained multi-domain language model, the updated plurality of base layers, the updated plurality of domain general adapter layers, and the updated set of domain specific adapter layers.

16. The system of claim 15, wherein:
training the plurality of domain general adapter layers further comprises passing the domain general labeled dataset through the updated plurality of base layers and the plurality of domain general adapter layers,
training the set of domain specific adapter layers further comprises passing the domain specific labeled dataset through the updated plurality of domain general adapter layers and the set of domain specific adapter layers, and
training the plurality of domain general adapter layers and the set of domain specific adapter layers are performed independently and in parallel.

17. The system of claim 15, wherein the data repository further stores an unlabeled dataset, and wherein the system further comprises:
a server controller configured, when executed by the processor, to:
apply, to generate the domain general labeled dataset, a large language model to the unlabeled training dataset, wherein applying is performed according to a prompt that instructs the large language model to identify a subset of unlabeled data in the unlabeled training dataset as assigned to the domain general labeled dataset;
generate the domain general labeled dataset by applying domain general labels to the subset of unlabeled data;
apply, to generate the domain specific labeled dataset, a large language model to the unlabeled training dataset, wherein applying is performed according to a prompt that instructs the large language model to identify a subset of unlabeled data in the unlabeled training dataset as assigned to the domain specific labeled dataset;
generate the domain specific labeled dataset by applying domain specific labels to the subset of unlabeled data;
apply, to generate a second domain specific labeled dataset, a large language model to the unlabeled training dataset, wherein applying is performed according to a prompt that instructs the large language model to identify a second subset of unlabeled data in the unlabeled training dataset as assigned to the second domain specific labeled dataset;
generate the second domain specific labeled dataset by applying second domain specific labels to the second subset of unlabeled data; and
train, to generate an updated second set of domain specific adapter layers, a second set of domain specific adapter layers on the second domain specific labeled dataset,
wherein training the second set of domain specific adapter layers excludes updating the plurality of domain general adapter layers, and
wherein training the second set of domain specific adapter layers excludes updating the set of domain specific adapter layers; and
wherein returning further comprises returning, as part of the trained multi-domain language model, the updated second set of domain specific adapter layers.

18. The system of claim 15, wherein:
the updated plurality of domain general adapter layers is trained to identify, when executed, whether a plurality of prompts submitted to a large language model are permissible or impermissible,
the updated set of domain specific adapter layers is trained to identify, when executed, whether a first prompt in the plurality of prompts submitted to the large language model is permissible or impermissible when the first prompt is assigned to a first domain, and
a second updated set of domain specific adapter layers of the multi-domain language model is excluded from executing on the first prompt.

19. The system of claim 15, further comprising a server controller which, when executed by the processor, is configured to:
receive a prompt;
identifying a domain type of the prompt as belonging to the set of domain specific adapter layers; and
applying the trained multi-domain language model to the prompt, wherein applying further includes only executing the updated plurality of base layers, the updated plurality of domain general adapter layers, and the updated set of domain specific adapter layers during application of the trained multi-domain language model to the prompt.

20. A method comprising:
receiving a multi-domain language model, comprising:
a plurality of base layers,
a plurality of domain general adapter layers,
a first set of domain specific adapter layers, and
a second set of domain specific adapter layers;
training, to generate an updated plurality of base layers, the plurality of base layers on an unlabeled training dataset;
training, to generate an updated plurality of domain general adapter layers, the plurality of domain general adapter layers on a domain general labeled dataset generated from the unlabeled training dataset,
wherein training the plurality of domain general adapter layers excludes updating the first set of domain specific adapter layers;
training, to generate an updated first set of domain specific adapter layers, the first set of domain specific adapter layers on a first domain specific labeled dataset generated from the unlabeled training dataset,
wherein training the first set of domain specific adapter layers excludes updating the plurality of domain general adapter layers;
returning, as a trained multi-domain language model, the updated plurality of base layers, the updated plurality of domain general adapter layers, and the updated first set of domain specific adapter layers;
training, to generate an updated second set of domain specific adapter layers, the second set of domain specific adapter layers on a second domain specific labeled dataset generated from the unlabeled training dataset,
wherein training the second set of domain specific adapter layers excludes updating the plurality of domain general adapter layers, and
wherein training the second set of domain specific adapter layers further excludes updating the first set of domain specific adapter layers;
returning, as a trained multi-domain language model, the updated plurality of base layers, the updated plurality of domain general adapter layers, the updated first set of domain specific adapter layers, and the updated second set of domain specific adapter layers.
